(19) United States
(12) Patent Application Publication
(10) Pub. No.: US 2022/0091272 A1
(43) Pub. Date: Mar. 24, 2022

(54) SHOCK FRONT LIDAR AIR DATA METHOD AND SYSTEM

(71) Applicant: Honeywell International Inc., Charlotte, NC (US)

(72) Inventors: Timothy A. Peterson, Minneapolis, MN (US); Lee R. Wienkes, Minneapolis, MN (US)

(73) Assignee: Honeywell International Inc., Charlotte, NC (US)

(21) Appl. No.: 17/218,706

(22) Filed: Mar. 31, 2021

Related U.S. Application Data
(60) Provisional application No. 63/081,770, filed on Sep. 22, 2020.

(51) Int. Cl. G01S 17/933; G01S 7/481; B64C 30/00

(52) U.S. Cl. CPC G01S 17/933; B64C 30/00; G01S 7/4816; G01S 7/4814

(57) ABSTRACT

An air data method and system are disclosed. In one implementation, the method comprises obtaining one or more data measurements from an interrogation region with at least one light detection and ranging (LiDAR) unit along at least one line of sight. The method further comprises sending the one or more data measurements to a processor operative to perform data processing. The data processing includes extracting one or more shock front distances from the one or more data measurements, and calculating one or more shock front angles from the one or more shock front distances. The data processing further includes calculating one or more air data parameters from the one or more shock front angles.

### CROSS-REFERENCE TO RELATED APPLICATIONS

This application claims the benefit of priority to U.S. Provisional Application No. 63/081,770, filed on Sep. 22, 2020, which is herein incorporated by reference.

### BACKGROUND

Supersonic aircraft, such as military fighter aircraft, hypersonic missiles, or supersonic commercial jets, utilize air data sensor feedback to the pilot or flight management system to maintain flight control. Critical air data parameters may include angle of attack (α) and angle of sideslip (β), as well as Mach number (M). Air data availability is exceedingly critical for maintaining control of dynamically unstable supersonic aircraft, which may require fly-by-wire automatic computer control loops.

Traditional air data sensors include pitot-static probes and angle of attack vanes. These systems suffer from certain drawbacks including, but not limited to: 1) source error corrections requiring calibration; 2) external protrusions or orifices prone to foreign object damage; and 3) sensor bandwidth limitations due to the mechanical nature of sensing action.

Optical air data systems may address such drawbacks by use of remote sensing through flush-mounted aircraft windows, wherein the backscatter of broadcast laser light is analyzed to infer air data parameters. However, optical air data systems most typically operate in Doppler velocimetry mode, which requires costly, high performance laser and sensor technology to perform the Doppler velocimetry.

Thus, there is a need to provide supersonic aircraft with an air data system having dissimilar failure modes to traditional vane/pitot systems, and without the costly and complicated nature of existing Doppler optical air data systems.

### SUMMARY

An air data method and system are described herein. In one implementation, the method comprises obtaining one or more data measurements from an interrogation region with at least one light detection and ranging (LiDAR) unit along at least one line of sight. The method further comprises sending the one or more data measurements to a processor operative to perform data processing. The data processing includes extracting one or more shock front distances from the one or more data measurements, and calculating one or more shock front angles from the one or more shock front distances. The data processing further includes calculating one or more air data parameters from the one or more shock front angles.

### BRIEF DESCRIPTION OF THE DRAWINGS

Exemplary features of the present disclosures will be apparent from the accompanying drawings. Non-limiting and non-exhaustive embodiments are described with reference to the accompanying drawings, wherein like labels or reference numbers refer to like parts throughout the various views unless otherwise specified. The sizes and relative positions of elements in the drawings are not necessarily drawn to scale. One or more embodiments are described hereinafter with reference to the accompanying drawings in which:

FIG. 1 is a flow diagram of a method for operating a shock front light detection and ranging (LiDAR) air data system for determining air data parameters, according to one implementation;

FIG. 2 is a schematic representation of the operation of a shock front LiDAR air data system, according to one implementation;

FIG. 3 is a graphical representation of the operation of the shock front LiDAR air data system of FIG. 2; and

FIG. 4 is a block diagram of a system for determining air data parameters from a shock front LiDAR air data system, according to one embodiment.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, or electrical changes may be made. Furthermore, the method presented in the drawing figures and the specification is not to be construed as limiting the order in which the individual steps may be performed. The following detailed description is, therefore, not to be taken in a limiting sense.

A method and system for obtaining shock front light detection and ranging (LiDAR) air data are described herein.

The present approach provides an optical air data system primarily, though not exclusively, for supersonic aircraft, which operates by sensing the relative position of a shock front with respect to the aircraft frame. As used herein, the term “supersonic” means aircraft speeds exceeding the speed of sound in the surrounding air. Aircraft traversing at supersonic speeds exhibit a characteristic shock front feature that develops from leading edges. The position of the shock front can be utilized to infer angles of attack and side slip, and the Mach number. The system described herein, while optical, avoids the complexity and challenges associated with Doppler optical air data systems because the laser and detector requirements are significantly relaxed, as hyperspectral Doppler shift analysis is not required.

The present approach provides for the measurement of air data parameters by use of one or more light detection and ranging (LiDAR) measurements of the distances to a shock front. As used herein, the phrase “air data parameters” denotes a full or partial set of measurements carrying information about the airflow with respect to an aircraft. These include angle of attack (α) and angle of sideslip (β) and Mach number (M). The approach described herein can be configured to directly measure the Mach angle (μ) using at least two lines of sight, which may be used to calculate the Mach number via the expression M=1/sin(μ). The Mach number may be related to the true airspeed and static air temperature via the Newton-Laplace equation. If the LiDAR air data system described herein is combined with a LiDAR internal or external method of static temperature measurement, the true airspeed may be produced as well as the Mach number.

A shock front is a sharp air density feature, which is typically described by “N-wave” pressure profiles and results in the characteristic sonic boom associated with supersonic flight. See, e.g., Haglund, G. T., & Kane, E. J. (1974), Analysis of Sonic Boom Measurements Near Shock Wave Extremities for Flight Near Mach 1.0 and for Airplane Accelerations, (CR-2417); Maglieri, D. J., Ritchie, V. S., & Bryant, J. F. (1963), Nasa Technical Note, In-Flight Shock-Wave Pressure Measurements Above and Below a Bomber Airplane at Mach Numbers from 1.42 to 1.69, (TN D-1968); the disclosures of which are incorporated by reference herein. A bow shock front is a shock front that is experienced by the bow (or nose) of the aircraft. The system implementation is described herein with respect to the bow shock feature (adjacent to the nose of the aircraft), which provides a convenient shock front signature for LiDAR line of sight (LOS) instrumentation. However, the shock wave feature originating from any contour of an aircraft may be utilized without departing from the scope of the disclosure described herein.

Further details of various embodiments are described hereafter with reference to the drawings.

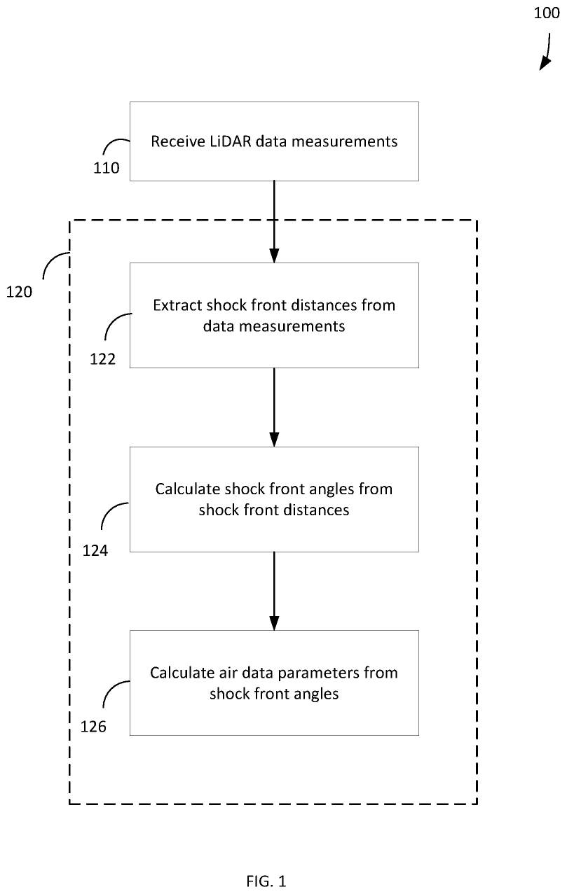

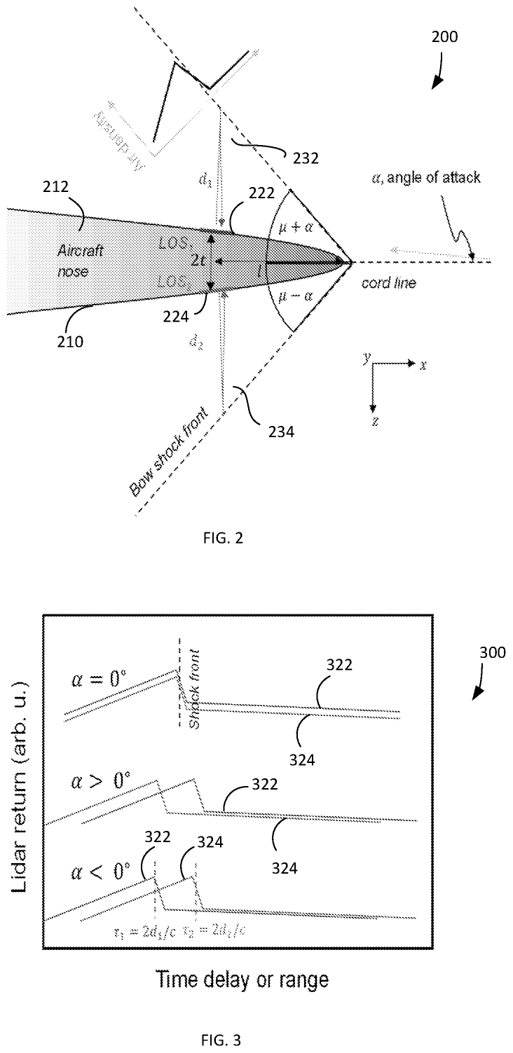

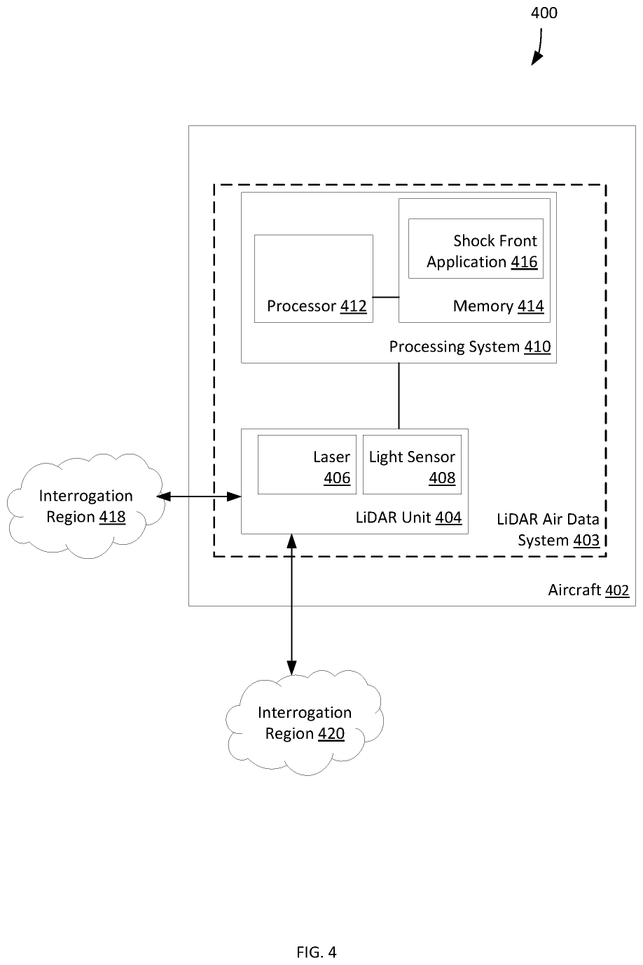

FIG. 1 is a flow diagram of a method 100 for operating a shock front LiDAR air data system for an aircraft. Initially, method 100 obtains one or more LiDAR data measurements from an interrogation region along one or more lines of sight (e.g., LOS₁, LOS₂, . . . LOS_{N}) (block 110). The interrogation region corresponds to a region of interest external to the aircraft, in which light transmitted along a plurality of distinct LOS vectors collides with matter in the interrogation region. In some embodiments, the interrogation region(s) coincide with a shock front area experienced by the aircraft. The scattered light from the transmitted light signals can be received (that is, detected) by the LiDAR air data system, as described further below with reference to FIGS. 2 and 4.

The LiDAR data measurements for each LOS are then sent to a data processing unit (block 120). The data processing unit is operative to extract one or more shock front distances from the LiDAR data measurements (block 122). The shock front distance is measured from a point of the aircraft to a shock front, which is illustrated herein as a bow shock front. In an example, two shock front distances are calculated from light signals that are transmitted from opposite sides of the aircraft. In this example, the LOS vectors can be approximately parallel to each other. However, any number or orientation of arbitrary LOS vectors can be used under the condition that sufficient LOS vectors are utilized to acquire a desired air data parameter.

The data processing unit is further operative to calculate one or more shock front angles from the shock front distances (block 124). A “shock front angle” measurement as used herein means a raw angle measurement (i.e. an angular measurement that is directly measured) corresponding to a shock front with respect to a reference axis (e.g. the centerline or other axis) of the aircraft. A shock front angle measurement can include physical quantities relating to other angular air data parameters, such as a combination of air data parameters, which can be separated using conventional processing techniques. For example, as described in further detail with reference to FIG. 2, a shock front angle measurement can include the quantity μ+α, which corresponds to the combined quantity of the Mach angle and the angle of attack.

The data processing unit is further operative to calculate one or more air data parameters from the shock front angles (block 126). The data processing unit may receive additional sensor data from an external input. Some air data parameters are angular quantities that are derived from the measured shock front angles. In the example above, the air data parameters μ and α can be extracted from the combined μ+α and μ−α measurements. The determined air data parameters are then output from the data processing unit for use in further navigation processing in the aircraft.

FIG. 2 is a schematic representation of the operation of a shock front LiDAR air data system 200, according to one implementation on an aircraft 210, such as a supersonic jet. As shown in FIG. 2, a first LiDAR unit 222 and a second LiDAR unit 224 are located on a nose 212 of aircraft 210. The distances d₁ and d₂ to a bow shock front in respective interrogation regions 232 and 234 is measured along each of LOS₁ and LOS₂ by analysis of the range-resolved backscattered return signal to LiDAR units 222 and 224.

The LiDAR units 222 and 224 operate in a similar fashion as traditional LiDAR units and as described in FIG. 4. The range is given from the time-delayed LiDAR return signal with the standard d=c/2τ expression, where c is the speed of light and τ is the time delay. In one embodiment, the LiDAR units 222 and 224 include a pulsed laser that emits a pulse of light directed along the LOS, and a fast photodetector (e.g., a photomultiplier or avalanche photodiode) triggered by the outgoing pulse records the time-resolved backscatter signal collected through colinear (or nearly colinear) receive optics. In one example implementation, the pulsed laser is a sub-nanosecond pulsed, ultraviolet laser for adequate range resolution and efficient Rayleigh scattering. The laser pulse energy is sufficiently large so that adequate shot-noise statistics are achieved to allow good feature resolution from the LiDAR return signal.

FIG. 3 is a graphical representation 300 of the operation of shock front LiDAR air data system 200. The graphical representation 300 includes measurements of the LiDAR return signal magnitude (vertical axis) for three different angles of attack, α, as a function of time delay or range (horizontal axis). The top set of lines correspond to an α=0, while the middle and bottom set of lines correspond to a being greater than or less than zero, respectively. For each return signal corresponding to LiDAR units 222 and 224 (signals 322 and 324 in FIG. 3, respectively), a shock front is illustrated as a sharp local peak preceding a sudden decrease in the return signal amplitude. After a shock front occurs, the return signal sharply decreases and subsequently plateaus. As shown in FIG. 3, the shock front distance along each LOS (d₁ and d₂) is determined by the time delay or range at which the LiDAR return signal experiences the local peak and subsequent plateau. The drop in LiDAR return signal magnitude occurs due to the air density feature that accompanies a shock front. The plateau corresponds to the LiDAR return signal from the unperturbed air in front of the aircraft bow shock front. The shock front signature on the LiDAR return signal may be fit and distances extracted with standard data processing techniques, such as, but not limited to, least-squares model fitting to N-wave models, or feature identification techniques such as derivative analysis. In addition, standard analog electronic methods may be used to measure the time delay directly from the LiDAR return detector signal. In one example, the time delay can be determined by measuring the time when the light beam is transmitted from the LiDAR unit (a first time), and measuring the subsequent time when the LiDAR unit receives a backscattered light signal (a second time). The time delay is then calculated as the difference between the first and second times.

The shock front distance measurement(s) may be used to infer shock front angles via the geometric relationships illustrated in FIG. 2. The shock front angles (e.g. μ+α) can then be processed to determine air data parameters such as the angles of attack and/or sideslip (α and β, respectively) and Mach angle β (which may be related to Mach number). As the Mach angle decreases, the distance to the shock front decreases along all LOS. As the angle of attack changes, an opposite distance change to the shock front is experienced by the up-facing LOS and the down-facing LOS. For certain geometries of the LOS and the Mach angle, straightforward expressions for α and μ are readily determined by trigonometry.

In the case of the two LOS bow shock configuration shown in FIG. 2, where the LOS transverse (side to side) offset from the cord line is t and LOS are oriented perpendicular to the cord line in the xz plane, the angle of attack α, and Mach angle μ may be given by the following expressions:

$$\begin{matrix}α = ( \frac{1}{2} ) ( arctan [ \frac{{d}_{1} + t}{l} ] - arctan [ \frac{{d}_{2} + t}{l} ] ) , & ( 1 ) \\ μ = ( \frac{1}{2} ) ( arctan [ \frac{{d}_{1} + t}{l} ] + arctan [ \frac{{d}_{2} + t}{l} ] ) , & ( 2 )\end{matrix}$$

where d₁, d₂ are respectively the shock front distance along LOS₁ and LOS₂, and l is the longitudinal (front to back) offset from the nose of the LOS bases. The same concept with side-facing LOS may be used to determine the angle of sideslip. For example, if the LOS were oriented in the xy plane, an identical expression to equation (1) above may be given for angle of sideslip β.

Fully general expressions for μ, α, β may be readily derived for arbitrary LOS orientation and number, transverse separation and nose offset l, with trigonometric relations such as the law of cosines. The supersonic airflow may be fully described by three independent angles, μ, α, β, which require, in general, at least three linearly-independent LOS measurements to uniquely constrain. If only a partial subset of μ, α, β are desired, less than three LOS are required. For instance, as shown in FIG. 1, two LOS may be configured to measure μ, α. In addition, a single LOS may be instrumented to measure one of μ, α, β, if the other parameters are provided from other probes or constrained a priori (e.g., it may be convenient to assume β=0). If more LOS than the minimum number required are present, these LOS may provide redundancy in case of individual LOS failure.

Additionally, non-analytic or calibrated expressions for air data parameters from shock front distance measurements may be used within the present approach. An example where this may be required is for transonic flight regime with blunt leading edge shapes, where the Mach number is not sufficient to form an attached conic shock cone and concavity is present. See, e.g., Ames research staff, & NACA (1953), Equation, Tables and Charts for Compressible Flow, (Report 1135), 73; the disclosure of which is incorporated by reference herein. Example ways to derive such non-analytic or calibrated expressions include flight tests, wind tunnel tests, and/or simulations.

FIG. 4 is a block diagram of a system 400 for determining air data parameters for an aircraft 402, using a shock front LiDAR air data system 403, according to an exemplary embodiment. The LiDAR air data system 403 generally includes at least one LiDAR unit 404, and a processing system 410 operatively coupled to LiDAR unit 404. The LiDAR unit 404 can be utilized as described above, and is coupled to the exterior of aircraft (e.g. supersonic jet) 402. Although only one LiDAR unit 404 is shown in air data system 403, additional LiDAR units may also be coupled at different locations around aircraft 402. Such additional LiDAR units can be configured to emit light at distinct line of sight vectors from aircraft 402.

The LiDAR unit 404 includes a laser 406 configured to emit a light beam external to aircraft 402 towards at least one interrogation region. Two such regions, interrogation region 418 and interrogation region 420, are illustrated in system 400, understanding that more or fewer regions may be used. A light sensor 408 is configured to detect a portion of the backscattered light that is reflected from interrogation regions 418 and 420. In some embodiments, light sensor 408 includes a photomultiplier or avalanche photodiode. The interrogation regions 418 and 420 are selected by LiDAR unit 404 at an appropriate distance from aircraft 402 (for example, through focusing optics) to encompass shock front events experienced by aircraft 402, thereby enabling LiDAR unit 404 to receive backscattered signals that correspond to the shock front events, and thus determine air data parameters based on the shock front measurements.

The LiDAR unit 404 sends data corresponding to the received backscattered light to processing system 410. The processing system 410 includes at least one processor 412 that is operative to perform data processing on the received data from LiDAR unit 404. In some embodiments, processing system 410 includes a memory 414 configured to store a shock front application 416. The processor 412 can be configured to execute the shock front application 416 stored in memory 414 to perform a data processing algorithm to determine air data parameters based on shock front distance measurements captured by LiDAR unit 404. For example, shock front application 416 can provide instructions to processor 412 so that, when executed, processor 412 performs a method similar to that described in FIG. 1. The air data parameters calculated from the shock front measurements can be sent to other systems or databases onboard aircraft 402 (e.g., flight management systems, flight control systems, navigation trajectory systems, integrity monitoring systems, etc.) to aid the aircraft during flight.

The processing unit and/or other computational devices used in the method and system described herein may be implemented using software, firmware, hardware, or appropriate combinations thereof. The processing unit and/or other computational devices may be supplemented by, or incorporated in, specially-designed application-specific integrated circuits (ASICs) or field programmable gate arrays (FPGAs). In some implementations, the processing unit and/or other computational devices may communicate through an additional transceiver with other computing devices outside of the navigation system, such as those associated with a management system or computing devices associated with other subsystems controlled by the management system. The processing unit and/or other computational devices can also include or function with software programs, firmware, or other computer readable instructions for carrying out various process tasks, calculations, and control functions used in the methods and systems described herein.

Instructions for carrying out the various process tasks, calculations, and generation of other data used in the operation of the methods described herein can be implemented in software, firmware, or other computer readable instructions, which can be executed by at least one processor or processing unit. Generally, program modules include routines, programs, objects, data components, data structures, algorithms, and the like, which perform particular tasks or implement particular abstract data types. Computer readable medium may be available media that can be accessed by a general purpose or special purpose computer or processor, or any programmable logic device.

Suitable computer readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer executable instructions or data structures.

### Example Embodiments

Example 1 includes a method comprising: obtaining one or more data measurements from an interrogation region with at least one light detection and ranging (LiDAR) unit along at least one line of sight; and sending the one or more data measurements to a processor operative to perform data processing comprising: extracting one or more shock front distances from the one or more data measurements; calculating one or more shock front angles from the one or more shock front distances; and calculating one or more air data parameters from the one or more shock front angles.

Example 2 includes the method of Example 1, wherein the interrogation region is outside of an aircraft during flight.

Example 3 includes the method of Example 2, wherein the aircraft is traveling at a supersonic speed.

Example 4 includes the method of Example 3, wherein the one or more shock front distances are bow shock front distances adjacent to a nose of the aircraft.

Example 5 includes the method of any of Examples 1-4, wherein the calculated one or more air data parameters comprise one or more of angle of attack, angle of sideslip, or Mach angle.

Example 6 includes the method of any of Examples 1-5, further comprising receiving one or more additional data measurements from a second LiDAR unit, and wherein the data processing comprises calculating one or more additional air data parameters using the one or more additional data measurements as a constraint.

Example 7 includes the method of any of Examples 1-6, wherein extracting one or more shock front distances further comprises calculating a time delay between a first time when a light beam along the at least one line of sight is transmitted from the at least one LiDAR unit and a second time when a backscattered portion of the light beam is received from the interrogation region, and determining the one or more shock front distances based on the time delay.

Example 8 includes the method of any of Examples 1-7, wherein the at least one line of sight comprises at least one redundant line of sight.

Example 9 includes a system comprising: a light detection and ranging (LiDAR) air data system, comprising: a LiDAR unit comprising a laser configured to generate and emit a light beam transmitted to at least one interrogation region along at least one line of sight; and a light sensor coupled to the laser and configured to receive a backscattered portion of the light beam; and a processing system coupled to the LiDAR unit, wherein the processing system is operative to: receive one or more data measurements corresponding to the backscattered portion of the light beam; extract one or more shock front distances from the one or more data measurements; calculate one or more shock front angles from the one or more shock front distances; and calculate one or more air data parameters from the one or more shock front angles.

Example 10 includes the system of Example 9, wherein the light sensor comprises a photomultiplier or an avalanche photodiode.

Example 11 includes the system of any of Examples 9-10, wherein the laser is configured to generate an ultraviolet sub-nanosecond pulse.

Example 12 includes the system of any of Examples 9-11, wherein the at least one interrogation region is outside of an aircraft during flight.

Example 13 includes the system of Example 12, wherein the aircraft is traveling at a supersonic speed.

Example 14 includes the system of Example 13, wherein the one or more shock front distances are bow shock front distances adjacent to a nose of the aircraft.

Example 15 includes the system of any of Examples 9-14, wherein the calculated one or more air data parameters comprise one or more of angle of attack, angle of sideslip, or Mach angle.

Example 16 includes a non-transitory computer readable medium including instructions which, when executed by one or more processing devices, cause the one or more processing devices to: receive one or more data measurements from at least one light detection and ranging (LiDAR) unit; extract one or more shock front distances from the one or more data measurements; calculate one or more shock front angles from the one or more shock front distances; and calculate one or more air data parameters from the one or more shock front angles.

Example 17 includes the non-transitory computer readable medium of Example 16, wherein the one or more data measurements are obtained by the at least one LiDAR unit along at least one line of sight from an interrogation region outside of an aircraft during flight, and wherein the one or more shock front distances are bow shock front distances adjacent to a nose of the aircraft.

Example 18 includes the non-transitory computer readable medium of any of Examples 16-17, wherein the calculated one or more air data parameters comprise one or more of angle of attack, angle of sideslip, or Mach angle.

Example 19 includes the non-transitory computer readable medium of any of Examples 16-18, wherein the instructions further cause the one or more processing devices to: receive one or more additional data measurements from a second LiDAR unit; and calculate one or more additional air data parameters using the one or more additional data measurements as a constraint.

Example 20 includes the non-transitory computer readable medium of any of Examples 17-19, wherein extracting the one or more shock front distances further comprises calculating a time delay between a first time when a light beam along the at least one line of sight is transmitted from the at least one LiDAR unit and a second time when a backscattered portion of the light beam is received from the interrogation region, and determining the one or more shock front distances based on the time delay.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method comprising:
obtaining one or more data measurements from an interrogation region with at least one light detection and ranging (LiDAR) unit along at least one line of sight; and
sending the one or more data measurements to a processor operative to perform data processing comprising:
extracting one or more shock front distances from the one or more data measurements;
calculating one or more shock front angles from the one or more shock front distances; and
calculating one or more air data parameters from the one or more shock front angles.

2. The method of claim 1, wherein the interrogation region is outside of an aircraft during flight.

3. The method of claim 2, wherein the aircraft is traveling at a supersonic speed.

4. The method of claim 3, wherein the one or more shock front distances are bow shock front distances adjacent to a nose of the aircraft.

5. The method of claim 1, wherein the calculated one or more air data parameters comprise one or more of angle of attack, angle of sideslip, or Mach angle.

6. The method of claim 1, further comprising receiving one or more additional data measurements from a second LiDAR unit, and wherein the data processing comprises calculating one or more additional air data parameters using the one or more additional data measurements as a constraint.

7. The method of claim 1, wherein extracting one or more shock front distances further comprises calculating a time delay between a first time when a light beam along the at least one line of sight is transmitted from the at least one LiDAR unit and a second time when a backscattered portion of the light beam is received from the interrogation region, and determining the one or more shock front distances based on the time delay.

8. The method of claim 1, wherein the at least one line of sight comprises at least one redundant line of sight.

9. A system comprising:
a light detection and ranging (LiDAR) air data system, comprising:
a LiDAR unit comprising:
a laser configured to generate and emit a light beam transmitted to at least one interrogation region along at least one line of sight; and
a light sensor coupled to the laser and configured to receive a backscattered portion of the light beam; and
a processing system coupled to the LiDAR unit, wherein the processing system is operative to:
receive one or more data measurements corresponding to the backscattered portion of the light beam;
extract one or more shock front distances from the one or more data measurements;
calculate one or more shock front angles from the one or more shock front distances; and
calculate one or more air data parameters from the one or more shock front angles.

10. The system of claim 9, wherein the light sensor comprises a photomultiplier or an avalanche photodiode.

11. The system of claim 9, wherein the laser is configured to generate an ultraviolet sub-nanosecond pulse.

12. The system of claim 9, wherein the at least one interrogation region is outside of an aircraft during flight.

13. The system of claim 12, wherein the aircraft is traveling at a supersonic speed.

14. The system of claim 13, wherein the one or more shock front distances are bow shock front distances adjacent to a nose of the aircraft.

15. The system of claim 9, wherein the calculated one or more air data parameters comprise one or more of angle of attack, angle of sideslip, or Mach angle.

16. A non-transitory computer readable medium including instructions which, when executed by one or more processing devices, cause the one or more processing devices to:
receive one or more data measurements from at least one light detection and ranging (LiDAR) unit;
extract one or more shock front distances from the one or more data measurements;
calculate one or more shock front angles from the one or more shock front distances; and
calculate one or more air data parameters from the one or more shock front angles.

17. The non-transitory computer readable medium of claim 16, wherein the one or more data measurements are obtained by the at least one LiDAR unit along at least one line of sight from an interrogation region outside of an aircraft during flight, and wherein the one or more shock front distances are bow shock front distances adjacent to a nose of the aircraft.

18. The non-transitory computer readable medium of claim 16, wherein the calculated one or more air data parameters comprise one or more of angle of attack, angle of sideslip, or Mach angle.

19. The non-transitory computer readable medium of claim 16, wherein the instructions further cause the one or more processing devices to:
receive one or more additional data measurements from a second LiDAR unit; and
calculate one or more additional air data parameters using the one or more additional data measurements as a constraint.

20. The non-transitory computer readable medium of claim 17, wherein extracting the one or more shock front distances further comprises calculating a time delay between a first time when a light beam along the at least one line of sight is transmitted from the at least one LiDAR unit and a second time when a backscattered portion of the light beam is received from the interrogation region, and determining the one or more shock front distances based on the time delay.
